(19) United States
(12) Patent Application Publication
(10) Pub. No.: US 2026/0145630 A1
(43) Pub. Date: May 28, 2026

(54) RADIATOR GRILLE FOR A MOTOR VEHICLE, AND MOTOR VEHICLE COMPRISING SUCH A RADIATOR GRILLE

(71) Applicant: AUDI AG, Ingolstadt (DE)

(72) Inventors: Andreas KOUKAL, Ingolstadt (DE); Jochen KÜRSCHNER, Ingolstadt (DE); Paul STAS, Stammham (DE); Manuel SCHNEIDER, Münchsmünster (DE)

(21) Appl. No.: 19/123,535

(22) PCT Filed: Aug. 1, 2023
(86) PCT No.: PCT/EP2023/071325

§ 371 Date: Apr. 23, 2025

(30) Foreign Application Priority Data
Nov. 3, 2022 (DE) 102022129054.9

(51) Int. Cl. B60R 19/52; B60Q 1/26; B60Q 1/28

(52) U.S. Cl. CPC B60R 19/52; B60Q 1/2696; B60Q 1/28

(57) ABSTRACT

A radiator grille for a motor vehicle is provided, the radiator grille comprising a grille body with a plurality of grille openings, wherein at least some of the grille openings are delimited by a surface which is provided with a top surface structure and which scatters light, and comprising a plurality of lighting elements, each of which illuminates a respective one of the surfaces.

### BACKGROUND

### Technical Field

The present disclosure relates to a radiator grille for a motor vehicle, comprising a grille body with a plurality of grille openings.

### Description of the Related Art

Motor vehicles usually have a radiator grille, which is provided at the front end and comprises a grille body with a plurality of grille openings that allow air to pass through to a radiator located behind the radiator grille, by way of which radiator cooling fluid is, for example, cooled. Since such a radiator grille, with its sometimes-considerable size, is arranged in a prominent position, namely at the front of the vehicle, it is known to provide a lighting device in the region of this radiator grille, which enables light to be emitted in the region of the radiator grille, which improves the visibility or alternatively recognizability of the motor vehicle.

DE 10 2020 130 590 A1 discloses a device with such a radiator grille, wherein the radiator grille is assigned a reflector, via which light from one or a plurality of lighting elements such as LEDs can be bundled and transmitted through the grid structure of the radiator grille.

DE 10 2020 209 963 A1 discloses a motor vehicle in which the radiator grille is assigned a light-optical communication device, via which light can be emitted through the radiator grille into the environment, so that a corresponding illumination image for transmitting a message can be displayed by projecting the light pattern onto it. The ability to open and close grille apertures in a targeted manner allows the light pattern to be varied.

The known devices are very elaborately designed and are based on radiating light through a radiator grille.

### BRIEF SUMMARY

According to embodiments of the invention, a radiator grille is provided for a motor vehicle, which radiator grille comprises a grille body with a plurality of grille openings, wherein at least some of the grille openings are delimited by a surface which is provided with a top surface structure and which scatters light, and comprising a plurality of lighting means or devices, each of which illuminates a surface.

The radiator grille according to embodiments of the invention offers the possibility of using the grille guard body itself as an illuminated and thus also light-emitting element. For this purpose, at least part of the grille openings is delimited by a surface with a defined top surface structure. This top surface structure is configured as a type of graining or defined top surface roughness in such a way that the light is diffusely scattered by the top surface structure when light falls on it. The grille openings defined by such a structured, light-scattering surface are each assigned a lighting means or device (e.g., lighting element), for example, an LED, which illuminates the respective assigned surface. Inasmuch as the light is reflected and diffusely scattered by the respective illuminated surface, the entire structured surface is ultimately visible as a uniform luminous surface. If a plurality of such surfaces is provided on the radiator guard, a correspondingly plurality of defined luminous surfaces can be seen on the radiator grille, which luminous surfaces are clearly delimited from non-illuminated grille regions. The radiator grille is clearly and unambiguously recognizable, which improves the detectability of the radiator grille and thus of course also of the motor vehicle equipped with it, meaning that people in the vicinity can, for example, better recognize the vehicle. Preceding vehicles can also better recognize the vehicle in the rear-view mirror, as the radiator grille is regularly visible in the rear-view mirror. The radiator grille that is illuminated or virtually self-illuminating in this manner can therefore even be used as a daytime running light, or at least in addition to other daytime running lights.

This is achieved by forming the defined top surface structure, which is to say, a defined roughness or grain of the reflective or luminous surface. This is because the diffuse scattering makes the surface appear as a correspondingly large luminous spot, which significantly improves discernability. Without such a top surface structure, which is to say, if the surface is flat and, as is often the case, painted, only the local light spot of the lighting means or device (e.g., lighting element) would be reflected on the surface, which is to say, as a small light spot that is sometimes difficult to discern.

It is moreover expedient if the surface provided with the top surface structure is provided with a light-reflecting coating. The reflectivity of the structured surface is increased by this coating. The top surface structure at the same time, prevents the coating from reflecting the light only selectively. The top surface structure therefore also allows such coated surfaces to be illuminated with the result that they are discerned as uniformly luminous surfaces.

In so doing, such a reflective coating can be a gloss finish, in particular a high-gloss finish, which is applied to the radiator grille either over the entire surface or locally, at least on the structured surfaces.

As explained, each structured surface is assigned a separate lighting means or device, for example, an LED. In order to arrange these as simply as possible on the grille body, an expedient further development of embodiments of the invention provides for the lighting means or device to be arranged on a common support, which is attached to the radiator grille. A lighting means or device support is therefore used, on which all the lighting means or devices are arranged. By mounting the support, which is easy to handle and install, all lighting means or devices are consequently fastened to the grille body in a single mounting process and fastened in a precise position, so that each lighting means or device is assigned to a structured surface and can illuminate it in the best possible way.

In so doing, the support is expediently configured as a support grille that comprises support openings corresponding to the grille openings. This means that the support grille openings are precisely aligned with the grille openings of the grille body. Such a support grille or such a support is, for example, a flexible plastic element that is on the one hand easy to manufacture, and on the other hand is easy to orient and assemble and can easily adapt to the geometry of the grille body due to its flexibility.

On the support grille, holders for attaching a lighting means or device are respectively provided, expediently adjacent to at least some of the support grille openings. The support grille, as a prefabricated component, is therefore already provided with corresponding holders to which the lighting means or devices can be fastened. These holders are expediently configured as snap-in holders to which the lighting means or devices are snap-engaged. Each lighting means or device therefore comprises a corresponding housing or the like so that it can be easily snap-engaged onto the snap-in holders. In the framework of the equipping of the support or support grille with the lighting means or devices, these therefore only need to be positioned and snap-engaged, which can be done easily.

As described, the support grille may be made of a flexible plastic material, which is to say, in the form of a mat, so that it can be easily mounted due to its flexibility and can adapt well to the structure of the grille body, which is usually made of a much harder plastic.

For easy assembly, connecting elements that can be connected to one another are expediently provided on the support or on the support grille and on the grille guard body, which in a further development of embodiments of the invention can be configured as locking elements. These locking elements in particular enable very simple assembly, since the support or respectively the support grille only needs to be positioned on the grille body and pressed against it, so that the locking elements snap together and a firm fastening is achieved. Of course, a screw connection is also possible.

The lighting means or devices themselves are connected either in series or in parallel and are expediently connected to a common connection device for connecting an external power supply. This means that all lighting means or devices can be supplied and also controlled by way of a common connection device. Corresponding supply lines from the connection device to the respective lighting means or devices can easily be laid at the rear side of the support or the support grille.

As described, LEDs that are sufficiently small and can be easily installed on the rear side of the support are advantageous lighting means or devices. They are characterized by a high light output combined with low power consumption.

In so doing, the lighting means or devices can preferably be RGB (RGB=red-green-blue) LEDs. These LEDs enable the generation of a wide variety of colors, so that the light color can be varied almost at will and consequently the radiator grille can also “light itself up” almost locally. In particular, the use of such LEDs makes it possible to change the color, if necessary, to switch, for example, from white light to red light, which is regularly discerned as a warning color, and the like.

In addition to the radiator grille itself, embodiments of the invention also relate to a motor vehicle comprising a radiator grille of the type described above.

The vehicle expediently comprises a control device for controlling the operation of the lighting means or devices. These can either be switched on permanently by default or can be switched on as required, for example, depending on the ambient light conditions, or upon request of the driver, who can switch the lighting operation on or off, for example, by way of an operating device such as a touchscreen with a corresponding operating menu.

In so doing, the lighting means or devices can only be controlled together, which is to say, all lighting means or devices light up together, meaning that the grille body is illuminated almost as much as possible. Alternatively, it is also conceivable that the lighting means or devices can be controlled separately or in different groups. This selective individual or grouped control makes it possible to create different lighting patterns or lighting scenarios. For example, groups of the lighting means or devices can blink alternately, wherein such blinking naturally increases discernability even further. It is also conceivable to have the individual groups light up in different colors, which also improves the warning function and the like.

### BRIEF DESCRIPTION OF THE SEVERAL VIEWS OF THE DRAWINGS

Further advantages and details of embodiments of the present invention are apparent from the embodiment examples described below and from the drawings.

FIG. 1 shows a partial view of a motor vehicle according to an example embodiment of the invention with a radiator protection grille according to an embodiment of the invention,

FIG. 2 shows a schematic representation of a part of the radiator grille from FIG. 1, showing the lighting means or devices (e.g., lighting elements) arranged on a grille body by way of a support grille and their illumination of the structured surfaces,

FIG. 3 shows a schematic representation of a support grille without lighting means or devices coupled thereto,

FIG. 4 shows a partial view of the support grille from FIG. 3 with a lighting means or device snap-engaged to it, and

FIG. 5 shows a partial view of the support grille with a lighting means or device including cabling.

### DETAILED DESCRIPTION

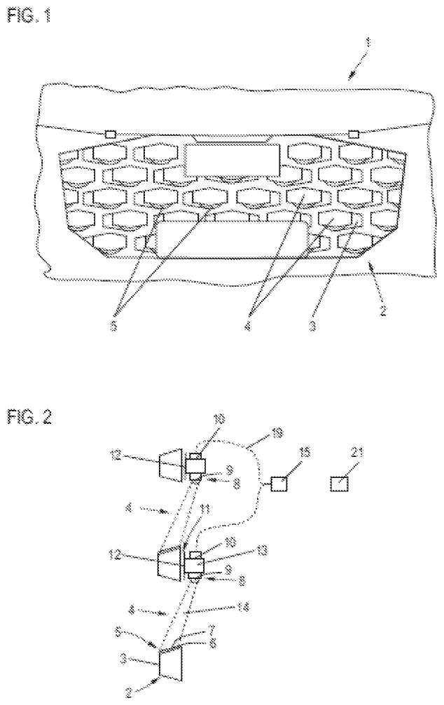

FIG. 1 shows a partial view of a motor vehicle 1 according to an embodiment of the invention with a radiator grille 2 according to an embodiment of the invention. This comprises a grille body 3, which is made of a suitable plastic material. The grille body 3 comprises a plurality of grille openings 4, in this regard see also FIG. 2, which are honeycomb-shaped in the example shown. At least some of the grille openings 4 are delimited at the lower edge by a surface 5, which comprises a light-scattering top surface structure 6 in the form of a defined roughness or grain, as shown in principle in FIG. 2. The surface 5 is covered with a high-gloss finish 7, which means that the top surface structure 6 is painted over, but it continues to define the top surface.

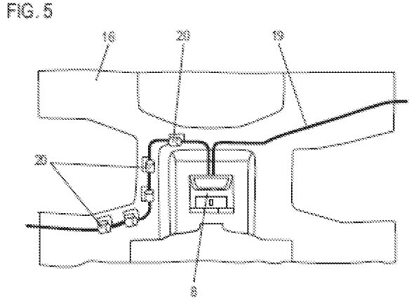

The structured surfaces 5 are respectively assigned a lighting means or device 8 (e.g., lighting element) in the form of an LED 9, which can be white light-emitting LEDs or RGB LEDs that can emit a wide variety of colors. Each lighting means or device 8 comprises a housing 10, by way of which it is fastened to a support 11 in the form of a support grille 12. For this purpose, the support grille 12 comprises corresponding snap-in holders 13 to which the housing 12 is snap-engaged, as shown in detail in FIG. 4.

The support 12 is configured as a support grille, which will be discussed below, wherein this support grille in the form of a mat can be easily attached to the rear side of the grille body 3.

As FIG. 2 shows, the individual lighting means or devices 8 are arranged in such a way that when they emit light, they radiate this light 14 directly onto the structured surface 5. The top surface structure 6, notwithstanding its glossy finish, reflects the incident light diffusely, so that the respective surface 5 is illuminated uniformly over the entire surface, despite more or less punctual illumination. Viewed from the front, which is to say, from the front of the radiator grille 2, each surface 5 ultimately illuminates itself, so to speak, and can therefore be recognized as a corresponding luminous surface.

A plurality of surfaces 5 can be provided over the surface of the grille body 3, thereby also a corresponding plurality of individual lighting means or devices 8. The lighting means or devices 8 are all expediently brought together on a common connection device 15, which enables the entire lighting device to be easily connected to a power supply, including also to a control device 21. This is because it is possible to control the operation of all the lighting means or devices 8 centrally by way of the control device 21. This control mode can be a simple on/off mode, which is to say, all lighting means or devices 8 are switched on and off together. Alternatively, it is also conceivable that each individual lighting means or device 8 can be controlled separately by way of the control device 21 so that any lighting means or devices 8 can be switched on or off. Groups of lighting means or devices 8 can also be formed that can be controlled separately. Individual control or group control of lighting means or devices 8 enable the generation of different lighting patterns or lighting scenarios on the grille body 3. A blinking is also possible, as are different colors if RGB LEDs are used.

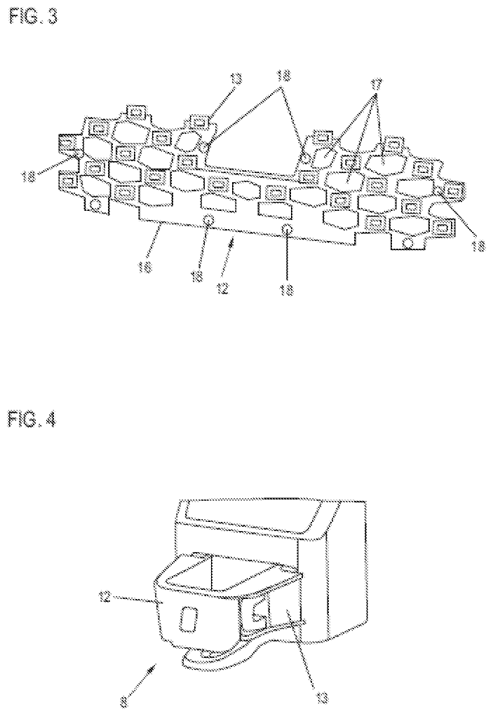

FIG. 3 shows a schematic representation of a support 12 in the form of a support grille 16. The support grille 16 comprises a plurality of individual support grille openings 17 which, after the support grille 16 is positioned on the rear side of the grille body 3, are precisely aligned with the grille openings 4 of the grille body 3. The previously described holders 13, which are shown in detail in FIG. 4, are provided on the support grille 16. The holders 13 comprise, for example, two lateral snap-in arms, between which the housing 12 of the respective lighting means or device 8 is snap-engaged and fastened.

The support grille 16 may be provided with a plurality of connecting elements 18 in the form of suitable locking elements, which snap-engage with corresponding locking elements on the rear side of the grille body 3. The support grille 16, which is already equipped with the lighting means or devices 8, is simply placed on the rear side of the grille body 3 and pressed on until the connecting elements 18 snap into place with those of the grille body 3, whereby the entire lighting device is fastened. All lighting means or devices 8 are positioned precisely in relation to the associated surface 5. As an alternative to the use of suitable locking elements as connecting elements, it is of course also conceivable that the connecting elements 18 are used to hold fastening screws, which are screwed to corresponding screw sections of the grille body 3.

Lastly, FIG. 5 shows a section of the support grille 16 with lighting means or devices 8 arranged on it and a cabling 19, which is also shown dashed in FIG. 2. This is ultimately used to connect all lighting means or devices 8, which can be connected either in series or in parallel. Corresponding retaining means 20 in the form of clamps and the like are provided on the support grille 16, to which the cabling 19 can be fastened and which also define the routing path. As described, the cabling 19 ends in the common connection device 15, which in turn is connected to an external power supply. The connection device 15 is also used to control the control device 21 of the motor vehicle 1 shown in FIG. 2, which controls the lighting operation of the lighting means or devices 8, whether by common control, by separate control or by group control, as well as, if possible, by corresponding control for varying or setting a specific light color.

If the lighting means or devices 8 are operated, they shine more or less only locally onto the respective surface 5, wherein the incident light is diffusely reflected due to the top surface structure 6, so that, seen from the front, each surface 5 “lights up” individually and uniformly, which is to say, forms a luminous surface. Due to the diffuse reflection, this is relatively sharply delimited from neighboring, non-illuminated surfaces or sections of the grille body 3, so that only the illuminated surfaces 5 can be discerned as a visible pattern. This light pattern is easy discernable, which is an advantage for safety reasons, since the radiator grille is almost discerned as a self-luminous component. As already described, the lighting pattern shown, which is to say, the number and position of the surfaces 5 that are actually illuminated, can moreover be varied by controlling the lighting means or devices 8 individually or in groups, so that, for example, a blinking occurs when different groups are controlled, or a kind of running light occurs when the individual lighting means or devices 8 are controlled in quick succession, just as blinking is of course also possible when they are controlled together. Of course, a corresponding color variation is also possible as described.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A radiator grille for a motor vehicle, comprising a grille body with a plurality of grille openings, wherein at least some of the grille openings are delimited by a surface which is provided with a top surface structure and which scatters light, and comprising a plurality of lighting elements, each of which illuminates a surface, wherein the lighting elements are arranged on a common support, which is attached to the rear side of the grille body.

2. The radiator grille according to claim 1, wherein the surfaces provided with the top surface structure are provided with a light-reflecting coating.

3. The radiator grille according to claim 2, wherein the light-reflecting coating is a gloss finish.

4. The radiator grille according to claim 1, wherein the common support is a support grille which comprises support grille openings corresponding to the grille openings of the grille body.

5. The radiator grille according to claim 4, wherein holders are provided on the support grille for each attaching a respective one of the lighting elements adjacent to at least one part of a respective one of the support grille openings.

6. The radiator grille according to claim 5, wherein the holders are configured as snap-in holders to which the lighting elements are snap-engaged.

7. The radiator grille according to claim 1, wherein the support is made of a flexible plastic material.

8. The radiator grille according to claim 1, wherein connecting elements which can be connected to one another are provided on the support and on the grille body.

9. The radiator grille according to claim 8, wherein the connecting elements are locking elements.

10. The radiator grille according to claim 1, wherein the lighting elements connected either in series or in parallel are connected to a common connection device for connecting to an external power supply.

11. The radiator grille according to claim 1, wherein the lighting elements are LEDs.

12. The radiator grille according to claim 11, wherein the lighting elements are RGB LEDs.

13. A motor vehicle comprising a radiator grille according to claim 1.

14. The motor vehicle according to claim 13, wherein a control device is provided for controlling the operation of the lighting elements.

15. The motor vehicle according to claim 14, wherein the lighting elements can only be controlled together, or in that the lighting elements can be controlled separately or in different groups.
